(19) United States
(12) Patent Application Publication
(10) Pub. No.: US 2006/0209816 A1
(43) Pub. Date: Sep. 21, 2006

(54) Method and equipment for implementing synchronous switching of CLOS cross connection matrix

(76) Inventors: Junan Li, Shenzhen (CN); Lei Xia, Shenzhen (CN); Hongxing Zhang, Shenzhen (CN)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/389,782

(22) Filed: Mar. 27, 2006

Related U.S. Application Data
(63) Continuation-in-part of application No. PCT/CN04/01102, filed on Sep. 27, 2004.

(30) Foreign Application Priority Data
Sep. 27, 2003 (CN) 03126414.X

(51) Int. Cl. H04L 12/56; H04L 12/50; H04Q 11/00; H04L 12/28

(52) U.S. Cl. 370/386; 370/389; 370/388

(57) ABSTRACT

The present invention discloses a method for implementing synchronous switching of cross connections of a CLOS cross connection matrix, comprising: the configuration controller calculating a new CLOS cross connection matrix according to the cross request, sending this new CLOS cross connection matrix to the cross nodes requiring synchronous switching, and sending synchronous switching signal to all the cross nodes requiring synchronous switching after receiving the ready signals returned by all the cross nodes requiring synchronous switching, and the cross nodes performing the synchronous switching immediately after receiving the synchronous switching signal. The present invention also discloses a digital cross connection equipment containing a configuration controller for implementing synchronous switching of a CLOS cross connection matrix. With the present invention, synchronous switching of the input stage, the central stage and the output stage can be guaranteed without instantaneous disconnections.

### CROSS-REFERENCE TO RELATED APPLICATIONS

This application is a continuation-in-part of PCT Application No. PCT/CN2004/001102, filed Sep. 27, 2004, pending, which designates the U.S., which is hereby incorporated herein by reference in its entirety, and which claims priority from Chinese Application No. 03126414.X, filed Sep. 27, 2003.

### FIELD OF THE INVENTION

The present invention relates to a method for implementing synchronous switching of a cross connection matrix and equipment thereof, and more particularly to a method for implementing synchronous switching of a CLOS cross connection matrix and equipment thereof.

### BACKGROUND OF THE INVENTION

In a Synchronous Digital Hierarchy/Synchronous Optical Network (SDH/SONET), a cross connection matrix is the core of synchronous digital cross connection equipment (hereinafter referred to as cross connection equipment). Typical cross connection matrixes include square matrix and CLOS cross connection matrix matrix.

By square matrix, cross connection can be implemented 100% without block, which, however, is only feasible when the cross capacity is relatively small since the scale of square matrix increases in a squaring exponential growth. When a large cross capacity is needed, the design complexity of square matrix will increase significantly and the cost of equipment will be considerable. In comparison, when the cross connection capacity is large, the number of cross nodes controlled by a CLOS cross connection matrix is much less than that controlled by a square matrix. Usually, the central stage of a CLOS cross connection matrix is of a constant capacity, and when a capacity expansion is required, only capacities of the input stage and output stage need to be expanded. Along with the development of telecommunications, the traffic increases continuously and large-capacity cross connection equipment has to be introduced, therefore CLOS cross connection matrix has become the main-steam matrix type in use for cross connection equipment.

Though the introduction of CLOS cross connection matrix reduces design complexity, it also greatly reduces the match ratio of cross connections, which results in frequent cross connection adjusting and instantaneous disconnections of part of/all the original cross connections when cross connections are changed.

As shown in FIG. 1, a CLOS cross connection matrix comprises an input stage, an output stage and a central stage, wherein each stage comprises three 3×3 cross nodes, and there are currently three cross connections, which are a->a, b->b and c->c. If a new cross connection x->y needs to be added, and since there is no path for the cross connection x->y, adjustments to the original cross connections are required.

As shown in FIG. 2, while adjusting, first the cross connection c->c is adjusted to 3×3 cross node #1 of the central stage, and then the new cross connection x->y can be added. However, what must be considered is: when adjusting a cross connection (adjusting the connection of c->c in the present instance), if the input stage, the central stage and the output stage are not switched synchronously, instantaneous disconnection will inevitably happen to the original cross connections.

As shown in FIG. 3, since no synchronous switching is conducted, when the input stage of the CLOS cross connection matrix has already switched the original cross connection c to the 3×3 cross node #1 of the central stage, the central stage still maintains the original cross connections, thus leading to instantaneous disconnection of the cross connection c.

The structure of the 3×3 cross nodes of the input stage, the output stage and the central stage are the same. FIG. 4 is a schematic diagram illustrating the structure of a 3×3 cross node according to the prior art, which comprises: a control interface 401, a CPU 402 and a 3×3 cross unit 403. Control interface 401 can be implemented by an original communication interface or by an expanded communication interface of the CPU. CPU 402 receives via control interface 401 such main control information as the configuration information and the control management information from the main control board of the cross connection equipment, and controls 3×3 cross unit 403 to intercross the received service data before outputting the data to the next stage or an external according to the configuration information.

To implement synchronous switching of a CLOS cross connection matrix, an in-band synchronous message mechanism is put forward. As rich overhead bytes are provided in a SDH/SONET frame structure, the in-band synchronous message mechanism can transfer synchronous switching message by inserting specific overhead bytes at a specific position.

When the system needs to switch cross connections synchronously, the input stage of the CLOS cross connection matrix will transfer specific overhead bytes at specific positions of the overheads to the central stage, and the central stage will transfer the specific overhead bytes downward to the output stage. After a synchronous message is received, the input stage, the central stage and the output stage will take synchronous switching actions as scheduled based on the positions of their own. In this way, synchronous switching of the CLOS cross connection matrix is realized and instantaneous disconnections are avoided while adjusting cross connections.

Although the in-band synchronous message mechanism provides a solution to synchronous configuration, there are some problems caused by the characteristics in the implementation of this message mechanism.

1. Since synchronous switching is implemented by inserting specific overhead bytes at a specific position, a set of synchronous switching protocols are needed and pure hardware logic needs to be added in each stage to implement the protocols, thus the cost is relatively high.

2. The in-band synchronous message mechanism is of poor applicability and can not meet the requirements of various occasions of application; for instance, the protocol applicable to 3-stage CLOS cross connection matrix is not applicable to 4-stage CLOS cross connection matrix, i.e. different protocols have to be developed based on different CLOS cross connection matrixes in order to implement the in-band synchronous message mechanism.

### SUMMARY OF THE INVENTION

In view of the above, the present invention is to provide a method for implementing synchronous switching of a CLOS cross connection matrix, which guarantees synchronous switching of the input stage, the central stage and the output stage thereof and avoids the phenomenon of instantaneous disconnection.

The present invention is also to provide a digital cross connection equipment, which guarantees synchronous switching of the input stage, the central stage and the output stage of a CLOS cross connection matrix and avoids the phenomenon of instantaneous disconnection.

The method for implementing synchronous switching of a CLOS cross connection matrix, comprising the steps of:

a) submitting a cross connection request to a configuration controller;

b) after receiving the cross connection request, calculating a new CLOS cross connection matrix by the configuration controller according to the cross connection request;

c) according to the cross connection request, sending the new CLOS cross connection matrix from the configuration controller to all the cross nodes requiring synchronous switching;

d) after getting ready for switching, returning a ready signal from the cross nodes requiring synchronous switching to the configuration controller;

wherein after all the cross nodes requiring synchronous switching have returned the ready signals, the configuration controller sends a synchronous switching signal to instruct all the cross nodes requiring synchronous switching to perform a cross matrix switching;

e) switching immediately to the new CLOS cross connection matrix by all the cross nodes that have received the synchronous switching signal from the configuration controller.

The said cross nodes requiring synchronous switching may comprise all the cross nodes of the CLOS cross connection matrix, or comprise all the cross nodes of the CLOS cross connection matrix whose cross matrix are changed and requires synchronous switching.

Step b) may comprise:

b-1) judging the number of the cross connection requests received, if there is only one connection request received at one moment, the configuration controller calculating a new CLOS cross connection matrix according to the connection request; otherwise, if there are a plurality of connection requests received at one moment, proceeding to step b-2);

b-2) the configuration controller filtering the connection requests, continuously calculating new CLOS cross connection matrixes until all the connection requests are processed, and obtaining a final CLOS cross connection matrix to be sent.

In this method, the synchronous switching signal sent by the configuration controller is implemented by hardware.

In Step d), if not all the ready signals from the cross nodes requiring synchronous switching are received during a predefined time span T0, the configuration controller may directly trigger a synchronous switching signal, i.e. sending a synchronous switching signal to the cross nodes that have returned the ready signal and completing synchronous switching; and resends to the cross nodes that have not returned a ready signal the CLOS cross connection matrix so that asynchronous switching can be implemented.

Alternatively, in Step d), if not all ready signals from the cross nodes requiring synchronous switching are received during a predefined time span T0, the configuration controller may abandon the current synchronous switching procedure and perform step c) once again.

In step d), after the configuration controller finishes sending the synchronous switching signal, the configuration controller may check whether each of the cross nodes requiring synchronous switching has returned a switching completed signal, and resend the CLOS cross connection matrix to the cross nodes requiring synchronous switching but having not returned the switching completed signal within the predefined time span T1.

The ready signal and switching completed signal may be implemented by a software protocol.

In this method, a configuration control unit of the configuration controller is used for receiving the cross connection request, calculating the new CLOS cross connection matrix according to the connection request, and sending the new CLOS cross connection matrix to those cross nodes requiring synchronous switching through a configuration interface of the configuration controller; and after receiving the ready signals returned by those cross nodes requiring synchronous switching through the configuration interface, the configuration control unit sends a synchronous switching signal to all the synchronous cross nodes requiring synchronous switching.

The configuration control unit can be implemented either by a CPU or a programmable logic device.

The configuration control unit can also be implemented by a CPU on a main control board of the digital cross connection equipment.

The digital cross connection equipment for implementing synchronous switching of a CLOS cross connection matrix according to the present invention, comprising a main control board and cross nodes, wherein a configuration controller is configured in the digital cross connection equipment,

the configuration controller receives a cross connection request, calculates a new CLOS cross connection matrix according to the connection request, and sends the new CLOS cross connection matrix to the cross nodes requiring synchronous switching; and after receiving ready signals from all the cross nodes requiring synchronous switching,

the configuration controller sends a synchronous switching signal to those cross nodes requiring synchronous switching; the main control board is connected to the configuration controller and the cross nodes, respectively, and is used for receiving cross connection requests from the outside, submitting cross connection requests to the configuration controller; and sending control commands to the cross nodes to control and manage the cross nodes; and

the cross nodes requiring synchronous switching perform synchronous switching according to the synchronous switching signal sent by the configuration controller.

The configuration controller comprises at least a configuration control unit and a configuration interface;

the configuration control unit is used for receiving the cross connection requests, calculating the new CLOS cross connection matrix according to the connection requests, and then sending the new CLOS cross connection matrix to the cross nodes requiring synchronous switching; and after receiving the ready signals returned by those cross nodes requiring synchronous switching through the configuration interface, the configuration control unit will send a synchronous switching signal to all the cross nodes requiring synchronous switching.

The configuration control unit can be implemented either by a CPU or a programmable logic device.

The configuration control unit can also be implemented by a CPU on a main control board of the digital cross connection equipment.

It can be seen from the above technical scheme that, with the method and equipment for implementing synchronous switching of a CLOS cross connection matrix in accordance with this invention, a configuration controller for centralized control of synchronous switching is configured inside the digital cross connection equipment, which is used for sending a synchronous signal to each cross node simultaneously, so that the cross nodes perform switching immediately after receiving the switching signal. Thus it is guaranteed that instantaneous disconnections will not happen during a synchronous switching of the input stage, the central stage and the output stage of the CLOS cross connection matrix.

### BRIEF DESCRIPTION OF THE DRAWINGS

FIG. 1 is a schematic diagram illustrating a cross connection block happening to a CLOS cross connection matrix in the prior art;

FIG. 2 is a schematic diagram illustrating a new cross connection successfully added after the CLOS is adjusted with the method in the prior art;

FIG. 3 is a schematic diagram illustrating an instantaneous disconnection happening to the original cross connections during the switching of a CLOS cross connection matrix in the prior art;

FIG. 4 is a schematic diagram illustrating the structure of a 3×3 cross node in the prior art;

FIG. 5 is a schematic diagram illustrating the procedure of a CLOS cross connection matrix implementing synchronous switching under the control of a configuration controller according to an embodiment of the present invention;

FIG. 6 is a schematic diagram illustrating the structure of the configuration controller and the connection with the input stage thereof according to a first exemplary embodiment of the present invention;

FIG. 7 is a flowchart illustrating a first processing approach of the configuration controller in the embodiment shown in FIG. 6;

FIG. 8 is a flowchart illustrating a second processing approach of the configuration controller in the embodiment shown in FIG. 6;

FIG. 9 is a schematic diagram illustrating the structure of the configuration controller and the connection with the input stage thereof according to a second exemplary embodiment of the present invention.

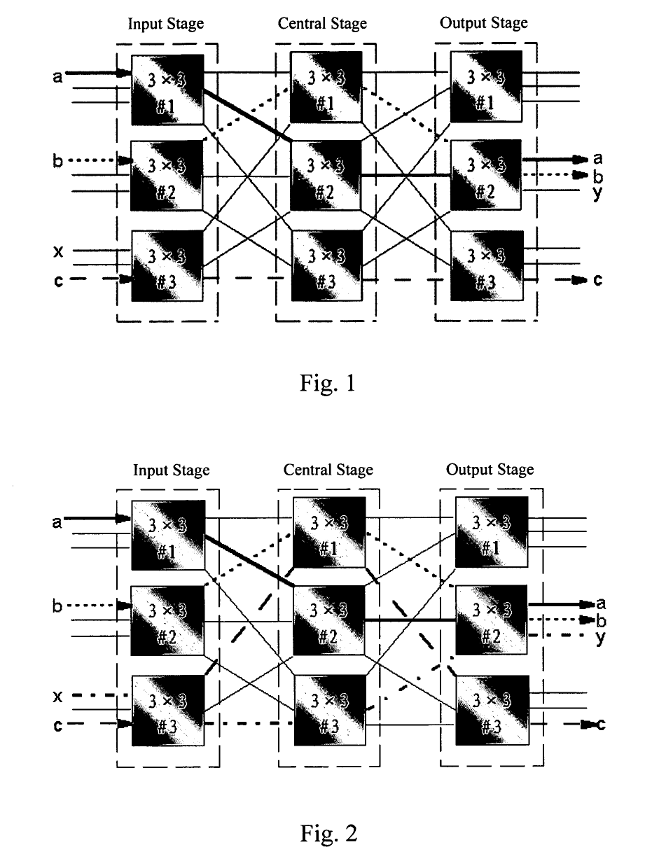

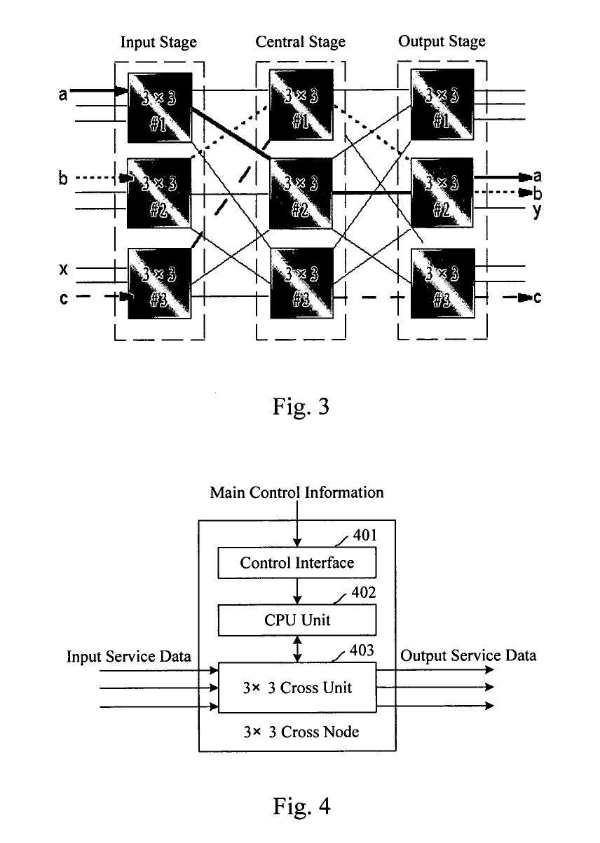

### DETAILED DESCRIPTION OF THE INVENTION

The embodiments of the present invention will be described hereinafter with reference to the accompanying drawings.

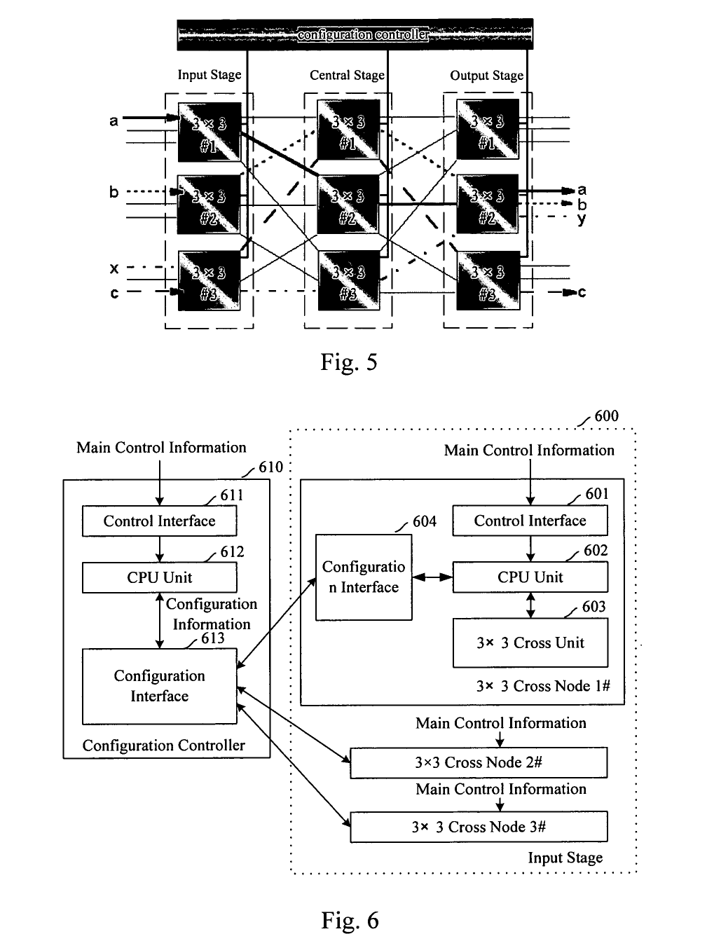

As shown in FIG. 5, in accordance with the method and equipment for implementing synchronous switching of a CLOS cross connection matrix, a configuration controller for centralized control of synchronous switching is configured inside the digital cross connection equipment, which is used for sending a synchronous switching signal to all the cross nodes at the same time so that each of the cross nodes can perform switching immediately on receiving the switch signal.

There are two ways to configure a configuration controller in the digital cross connection equipment according to the present invention: one is to configure in the equipment a separate configuration controller comprising at least a configuration control unit; the other is to integrate the function of the above-mentioned configuration control unit in a CPU module on the main control board of the equipment. The two ways will be illustrated hereinafter with reference to two embodiments, respectively.

### Embodiment 1

The present embodiment is the embodiment of the first way mentioned above. FIG. 6 is a schematic diagram illustrating the structure of the configuration controller and the connection thereof with the input stage according to this exemplary embodiment of the present invention.

In the present embodiment, the main control board of the equipment is connected to a configuration controller 610 and cross nodes of each stage, respectively, wherein the main control board receives cross connection requests from the outside, submits the cross connection requests to the configuration controller 610 and sends control commands to the cross nodes to control and manage the cross nodes. In the present embodiment, both the information sent to the configuration controller 610 by the main control board and the information of the control and management commands sent to 3×3 cross nodes by the main control board are called main control information.

In FIG. 6, the configuration controller 610 comprises: a control interface 611, a configuration control unit 612 and a configuration interface 613. The configuration control unit 612 receives such main control information as cross connection requests sent by the main control board through the control interface 611, recalculates a CLOS cross connection matrix according to the cross connection request, sends the new CLOS cross connection matrix to each 3×3 cross node of the input stage 600 through the configuration interface 613, and sends a synchronous switching signal to each 3×3 cross node at the same time according to the ready signals returned by the 3×3 cross nodes. In the present embodiment, the configuration control unit 612 can also receive the switching completed signals returned by the 3×3 cross nodes through the configuration interface 613, and perform switching once again or other processing according to the received signals.

The configuration control unit 612 in the present embodiment can be implemented by a CPU or a programmable logic device.

In the present embodiment, the configuration interface 613 of the configuration controller 610 can be implemented by a commonly known Ethernet communication circuit or other communication circuits, such as a self-provided or extended interface 485, RS232, or RS422 of the CPU, or by a self-developed interface so long as the communication function can be realized.

In order to work with the configuration interface 613 of the configuration controller 610, a configuration interface 614 is configured in 3×3 cross nodes in the present embodiment. Likewise, the configuration interface 614 can be implemented by a communication interface of the CPU or an extended communication interface, or just by the control interface 601.

The configuration interface 613 of the configuration controller 610 and the configuration interface 604 in a 3×3 cross node can be connected via a data line and a control line, wherein the data line is used for transmitting information, such as a calculated CLOS cross connection matrix; and the control line is used for transmitting synchronous switching signals sent by the configuration controller 610 as well as control signals returned to the configuration controller 610 from the 3×3 cross nodes, such as a ready signal or a switching completed signal. There are many specific ways for implementing the transmission of the signals, such as by an electrical level interrupt, a pulse interrupt or signals with different duty ratios, and the pulse interrupt may be a low pulse interrupt, a high pulse interrupt, etc.

Obviously, the data line, which connects the configuration interface 613 of the configuration controller 610 and the configuration interface 604 in a 3×3 cross node, can be used not only to transmit information such as a calculated CLOS cross connection matrix, but also to transmit control signals such as a ready signal or a switching completed signal. In such a case, the ready signal and the switching completed signal are generated by a software protocol and are sent to the configuration controller 610 via the data line.

For example, a protocol may be defined as follows: destination node ID (4 bytes)+source node ID (4 bytes)+command code (4 bytes)+parameter length (4 bytes)+command parameter (N bytes).

The destination node ID is used for identifying the receiving party of the protocol;

The source node ID is used for identifying the sending party of the protocol;

The command code is used for distinguishing the function of this protocol, such as 0x5as5a may be used for denoting a ready signal and 0xa5a5 for denoting a switching completed signal;

The parameter length denotes the parameter length of the subsequent command parameter.

The command parameter denotes the specific parameters to be carried by the command code, which can be null in this protocol.

The node ID 0xffffffff is allocated for the configuration controller, and each cross node is allocated with a node ID not identical with each other. When the cross node 1 is ready, a protocol as 0xffffffff 0x000000010x5a5a 0x0 is sent to the configuration controller to notify the configuration controller that the cross node 1 is ready; likewise, when the cross node 1 finishes switching, a protocol as 0xffffffff 0x00000010xa5a5 0x0 is sent to the configuration controller to notify the configuration controller that the cross node 1 has finished switching.

In this embodiment, the connections of the configuration controller 610 with the central stage and the output stage are the same as the connection between the configuration controller and the input stage, which are thus not further described here.

Once the configuration controller is introduced, all operations of adding and deleting cross connections are performed under the control of the configuration controller. In order to add/delete a cross connection, the main control board will submit the cross connection to be added/deleted to the configuration controller and the configuration controller will finish the entire corresponding process.

There are two approaches in this embodiment for the configuration controller to perform synchronous switching.

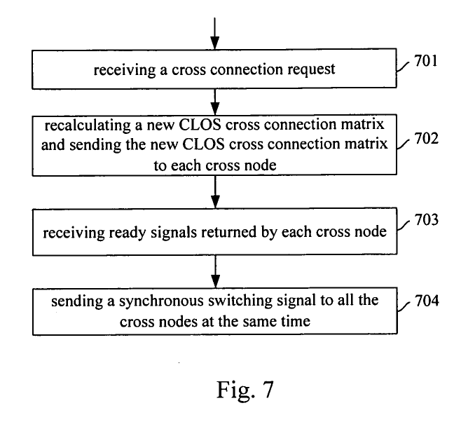

Referring to FIG. 7, which is a flowchart illustrating a first processing approach of the configuration controller in the embodiment shown in FIG. 6. This approach comprises the following four steps:

Step 701: the configuration controller receiving a request for adding/deleting a cross connection.

Step 702: the configuration controller calculating a new CLOS cross connection matrix and sending the new CLOS cross connection matrix to each cross node.

Since the method for calculating a CLOS cross connection matrix is already disclosed in related prior art, no further description thereof will be given here.

Step 703: the configuration controller receiving ready signals returned by each cross node.

Step 704: when every cross node returned a ready signal, the configuration controller immediately triggers a synchronous switching signal to send the synchronous switching signal simultaneously to each of the cross nodes so as to ensure that each cross node of the CLOS cross connection matrix performs a synchronous cross matrix switching.

In order to guarantee that the synchronous switching signals are received by the cross nodes almost at the same time, the synchronous switching signal should be implemented by a hardware interrupt line.

The above-mentioned first processing approach can fully guarantee the synchronous switching of cross nodes in a CLOS system under normal circumstances and avoid instantaneous disconnection while adjusting cross connections of the system. However, considering abnormal circumstances during a synchronous switching of the system, the synchronous switching procedure should be made strong and recoverable. Therefore, the above approach has to be improved so that the procedure can not only guarantee synchronous switching under normal circumstances but recover autonomously from malfunctioning.

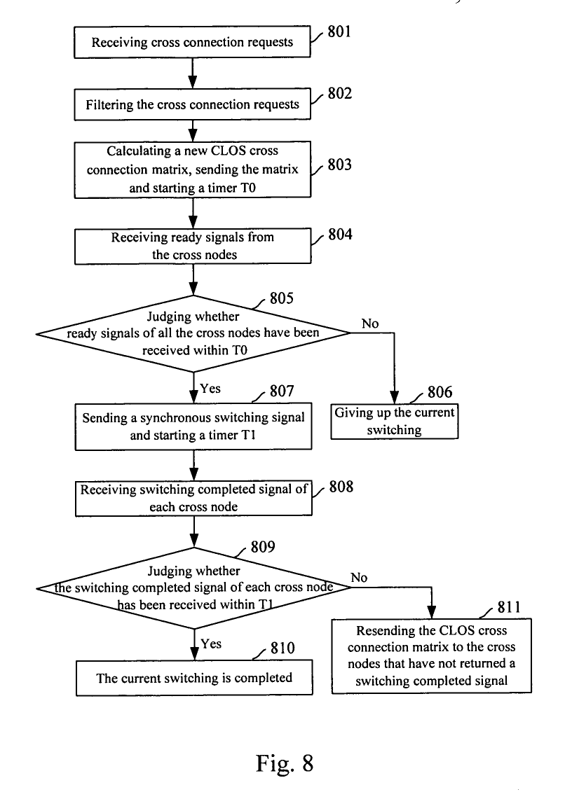

Thus, the first embodiment of the present invention also provides a second processing approach. Referring to FIG. 8, which is a flowchart illustrating the second processing approach of the configuration controller in the embodiment shown in FIG. 6. This approach comprises the following steps:

Step 801: the configuration controller receiving a request for adding/deleting a cross connection.

Step 802: judging whether there are a plurality of requests at one moment, if yes, the configuration controller making a filtering operation; otherwise, the configuration controller making no filtering operation.

The specific procedure of the filtering operation comprises: creating a buffer tank and putting all the cross connection requests into the buffer tank; instructing the configuration controller to make processing of the request when there is a new request in the tank. The configuration controller will not trigger synchronous switching immediately on finishing the processing of the current request, instead the controller will read the buffer tank again to check whether there is still a new request, for it is possible that a new request is received when the configuration controller is processing the previous request. If there is still a new request, the configuration controller will continue to calculate a CLOS cross connection matrix, and read the buffer tank again until there is no cross connection request in the buffer tank.

The foregoing is just a concrete example, and other protocols containing different functions can be adopted in practical applications. There are various implementing schemes, for instance, changing the positions of the fields in the above protocol, adding more fields to include more contents, modifying the length of each field to satisfy the requirement of the application.

Because all the cross connection changing requests are submitted to the configuration controller, a plurality of continuous cross connection requests will be filtered to get just one request so that not only the processing efficient of the system is improved but the designing complexity of software is reduced. Without filtering operation, when there are a plurality of cross connection changing requests, the system will perform such a procedure as: calculating a new CLOS cross connection matrix; sending the new CLOS cross connection matrix to each synchronous node for synchronous switching; calculating another CLOS cross connection matrix; and sending again the new CLOS cross connection matrix to each synchronous node for synchronous switching. While with the filtering operation, the system will perform a more efficient procedure: calculating a new CLOS cross connection matrix, and calculating another new CLOS cross connection matrix until all cross connection requests are processed, and sending the newest CLOS cross connection matrix to each synchronous node for synchronous switching.

Step 803: calculating a new CLOS cross connection matrix and sending the new CLOS cross connection matrix to those cross nodes whose cross matrixes are changed; meanwhile starting the timer for receiving a ready signal.

At this moment, the cross matrixes of some cross nodes are not changed while those of other cross nodes are changed; those cross nodes of which the cross matrixes are changed are synchronous cross nodes requiring synchronous switching while other nodes are non-synchronous cross nodes; synchronous cross nodes are included by all cross nodes, and constitutes a subset of the set of all cross nodes.

Since not all the cross matrixes change in practical applications, when only the cross matrixes of a small number of cross nodes change, there will be switching only in the cross nodes of which the cross matrixes have changed so as to increase efficiency, as in the present embodiment. The cross nodes of which the matrixes have changed so that synchronous switching is needed are synchronous cross nodes. Under the extreme circumstance, the matrixes of all the cross nodes may be changed so that synchronous switching is needed for all the cross nodes, then the set of all cross nodes is the same as that of synchronous cross nodes.

The time span for receiving a ready signal is the time for waiting for each synchronous cross node to return a ready signal. Waiting for a ready signal cannot be endless, instead, there should be a response within a certain time period, and thus the waiting time for a ready signal is called T0, which is preferably set as 30 milliseconds.

Step 804: receiving the ready signal sent by each cross node.

Step 805: judging whether all the ready signals sent by the cross nodes are received within the time T0, if yes, proceeding to step 807, otherwise proceeding to step 806.

Step 806: giving up the current switching.

Time out of T0 (namely time out for waiting for the ready signals) means that only some of the synchronous cross nodes complete the preparation for synchronous switching and the current synchronous switching is unsuccessful, which is an abnormal situation. If the communication circuit, status line and the processing part of software protocol are stable enough, such a situation will not happen. In order to guarantee the robustness of the synchronous switching procedure, the configuration controller in the present embodiment will abandon the current synchronous switching procedure and restart a second synchronous switch procedure. In this way, this method allows malfunctions of the cross nodes and is of a certain fault-tolerant capability.

Obviously, the configuration controller can also directly trigger a synchronous switching signal at this moment, i.e. send a synchronous switching signal to those cross nodes that have returned ready signals to finish the synchronous switching. The configuration controller will resend the CLOS cross connection matrix to those cross nodes that have not returned ready signals and non-synchronous switching will be performed. In this way, the method is also of a certain fault-tolerant capability.

Step 807: the configuration controller sending a synchronous switching signal to those cross nodes that have returned ready signals, and starting the timer for receiving a switching completed signal, wherein the time span thereof is the time T1 for waiting for each cross node to return a “switching completed signal” and T1 is preferably set as 500 milliseconds.

Step 808: receiving the switching completed signal sent by each cross node.

Step 809: judging whether the switching completed signals sent by all the cross nodes are received within the time T1, if yes, proceeding to step 810, otherwise proceeding to step 811.

Step 810: completing the current switching.

Step 811: checking whether each cross node has returned a switching completed signal, and resending the CLOS cross connection matrix to those cross nodes that have not returned switching completed signals.

### Embodiment 2

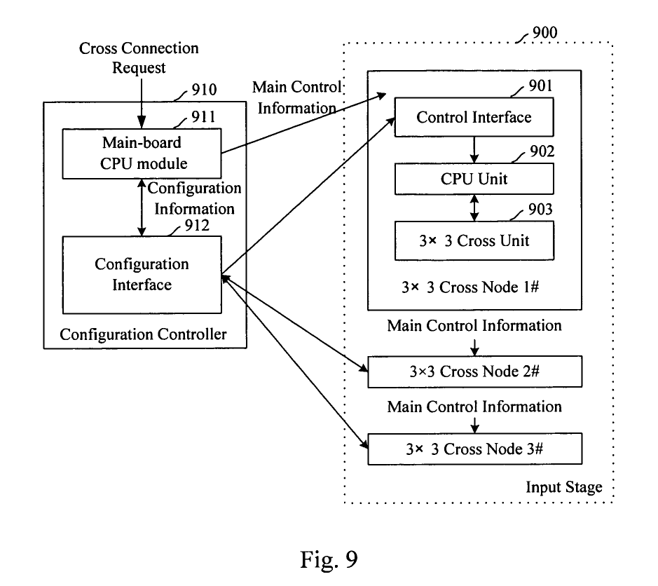

The present embodiment is the embodiment of the second implementing way mentioned above. FIG. 9 is a schematic diagram illustrating the structure of the configuration controller and the connection thereof with the input stage according to this second exemplary embodiment of the present invention.

In this embodiment, the configuration controller 910 comprises: a main-board CPU module 911 and a configuration interface 912. The main-board CPU model 911 receives cross connection requests from the outside, recalculates a CLOS cross connection matrix according to the cross connection requests, sends the new CLOS cross connection matrix to each 3×3 cross node in the input stage 900 through the configuration interface 912, and sends a synchronous switching signal to each 3×3 cross node simultaneously according to the ready signal returned by each 3×3 cross node. The main-board CPU module 911 of the present embodiment can also receive the switching completed signal returned by each 3×3 cross node through the configuration interface 912, and perform switching once again or perform other processing according to this signal. Apart from transmitting information to 3×3 cross nodes through the configuration interface 912, the main-board CPU module 911 also reserves the main control information like control management commands sent to 3×3 cross nodes.

In the present embodiment, the 3×3 cross nodes directly receive the information transmitted by the configuration controller 910 through the existing control interface 901.

The connection mode between the configuration interface 912 in the configuration controller 910 and the control interface 901 in the 3×3 cross node is identical to the connection mode between the configuration interface 613 in the configuration controller 610 and the control interface 604 in the 3×3 cross node, and no repeated description is given here.

In the present embodiment, connections of the configuration controller 910 with the central stage and the output stage are identical to that between the configuration controller 910 and the input stage, and no further description is given here.

Just like the embodiment shown in FIG. 6, there are two processing procedures for the configuration controller to perform synchronous switching in the present embodiment. The two procedures are completely the same as that shown in FIG. 7 and FIG. 8, and no further description is given here.

It can be seen from the above embodiments that the present invention makes it possible to implement the synchronous switching function of a CLOS cross connection matrix and avoids instantaneous disconnections when the cross connections are adjusted. The hardware system structure is relatively simple because the protocol part is implemented by software. In addition, the present invention is of wide applicability, not only applicable to the most common used 3-level CLOS cross connection matrix, but also applicable to higher-order CLOS cross connection matrixes; and the processing procedure of the protocols remains the same in applications with higher-order CLOS cross connection matrixes.

Furthermore, the present invention makes it possible to implement centralized control of cross connections in the system by introducing the configuration controller, wherein all the cross connection changing requests are submitted to the configuration controller and continuous cross connection requests will be filtered to obtain just one request so that the processing efficiency of the system is improved and the system control of cross connections is more simple and highly-efficient. Moreover, since time T0 of waiting for the ready signal and time T1 of waiting for the switching completed signal are introduced, the present invention can guarantee recoverability of the system in case of abnormality and thus further improve the reliability of the system.

The above description of the present invention is given with reference to specific embodiments and should not be construed as confining the present invention. Any modifications and variations made therein without departing from the spirit and scope of the invention are covered in protection scope of the present invention as defined by the appended claims.

1. A method for implementing synchronous switching of a CLOS cross connection matrix, comprising the steps of:
a) submitting a cross connection request to a configuration controller;
b) after receiving the cross connection request, calculating a new CLOS cross connection matrix by the configuration controller according to the cross connection request;
c) according to the cross connection request, sending the new CLOS cross connection matrix from the configuration controller to all the cross nodes requiring synchronous switching;
d) after getting ready for switching, returning a ready signal from the cross nodes requiring synchronous switching to the configuration controller;
wherein after all the cross nodes requiring synchronous switching have returned the ready signals, the configuration controller sends a synchronous switching signal to instruct all the cross nodes requiring synchronous switching to perform a cross matrix switching;
e) switching immediately to the new CLOS cross connection matrix by all the cross nodes that have received the synchronous switching signal from the configuration controller.

2. The method according to claim 1, wherein the cross nodes requiring synchronous switching comprise all the cross nodes of the CLOS cross connection matrix.

3. The method according to claim 1, wherein the cross nodes requiring synchronous switching comprise all the cross nodes of the CLOS cross connection matrix whose cross matrix are changed and requires synchronous switching.

4. The method according to claim 1, wherein step b) comprises:
b-1) judging the number of the received cross connection requests, if there is only one connection request received at one moment, the configuration controller calculating a new CLOS cross connection matrix according to the connection request; otherwise, if there are a plurality of connection requests received at one moment, proceeding to step b-2);
b-2) the configuration controller filtering the connection requests, continuously calculating new CLOS cross connection matrixes until all the connection requests are processed, obtaining a final CLOS cross connection matrix to be sent.

5. The method according to claim 1, wherein, the synchronous switching signal sent by the configuration controller is implemented by hardware.

6. The method according to claim 1, wherein, in step d), if not all the ready signals from the cross nodes requiring synchronous switching are received within a predefined time span T0, the configuration controller directly triggers a synchronous switching signal and sends it to the cross nodes that have returned the ready signal to complete the synchronous switching; and resends the CLOS cross connection matrix to the cross nodes that have not returned the ready signal and implement switching in a non-synchronous way.

7. The method according to claim 1, wherein, in step d), if not all the ready signals from the cross nodes requiring synchronous switching are received within a predefined time span T0, the configuration controller gives up the current synchronous switching procedure and performs step c) once again.

8. The method according to claim 1, wherein, after the step of triggering the synchronous switching signal in step d), the configuration controller checks whether each cross node requiring synchronous switching has returned a switching completed signal within a predefined time span T1, and resends the CLOS cross connection matrix to the cross nodes that have not returned a switching completed signal within a predefined time span T1.

9. The method according to claim 1, wherein the ready signal and the switching completed signal are implemented by software protocols.

10. The method according to claim 1, wherein a configuration control unit of the configuration controller is used for receiving the cross connection request, calculating the new CLOS cross connection matrix according to the connection request, and sending the new CLOS cross connection matrix to the cross nodes requiring synchronous switching through a configuration interface of the configuration controller; and after receiving ready signals returned by the cross nodes requiring synchronous switching through the configuration interface, the configuration control unit sends a synchronous switching signal to all the synchronous cross nodes requiring synchronous switching.

11. The method according to claim 10, wherein the configuration control unit is implemented by a CPU or a programmable logic device.

12. The method according to claim 10, wherein the configuration control unit is implemented by a CPU on a main control board of a digital cross connection equipment.

13. A digital cross connection equipment for implementing synchronous switching of a CLOS cross connection matrix, comprising a main control board and cross nodes, wherein a configuration controller is configured in the digital cross connection equipment;
the configuration controller receives a cross connection request, calculates a new CLOS cross connection matrix according to the connection request, sends the new CLOS cross connection matrix to the cross nodes requiring synchronous switching; and after receiving ready signals from all the cross nodes requiring synchronous switching, the configuration controller sends a synchronous switching signal to the cross nodes requiring synchronous switching;
the main control board is connected to both the configuration controller and the cross nodes, and is used for receiving cross connection requests from the outside, submitting the cross connection requests to the configuration controller, and sending control commands to the cross nodes to control and manage the cross nodes; and
the cross nodes requiring synchronous switching perform synchronous switching according to the synchronous switching signal sent by the configuration controller.

14. The digital cross connection equipment according to claim 13, wherein the configuration controller comprises a configuration control unit and a configuration interface; wherein
the configuration control unit is used for receiving cross connection requests, calculating a new CLOS cross connection matrix according to the connection requests, and then sending the new CLOS cross connection matrix to the cross nodes requiring synchronous switching through the configuration interface; and after receiving the ready signals returned by the cross nodes requiring synchronous switching through the configuration interface, the configuration control unit sends a synchronous switching signal to all the synchronous cross nodes requiring synchronous switching.

15. The digital cross connection equipment according to claim 14, wherein the configuration control unit is implemented by a CPU or a programmable logic device.

16. The digital cross connection equipment according to claim 14, wherein the configuration control unit is implemented by a CPU on a main control board of the digital cross connection equipment.
